(19) United States
(12) Patent Application Publication
(10) Pub. No.: US 2009/0093954 A1
(43) Pub. Date: Apr. 9, 2009

(54) Route search device and method for searching route

(75) Inventor: Ouhisa Seto, Nukata-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,472

(22) Filed: Oct. 7, 2008

(30) Foreign Application Priority Data
Oct. 9, 2007 (JP) 2007-263833

(51) Int. Cl. G01C 21/26

(52) U.S. Cl. 701/201; 701/209

(57) ABSTRACT

A route search device searches a route from a starting place to a destination based on a road data in a map data. The device includes: a path setting element for setting a path in a special section according to a search condition; and a route searching element for searching the route including the path of the special section. The special section is specified by an user, and the search condition is specified by the user regardless of the road data.

### CROSS REFERENCE TO RELATED APPLICATION

This application is based on Japanese Patent Application No. 2007-263833 filed on Oct. 9, 2007, the disclosure of which is incorporated herein by reference.

### FIELD OF THE INVENTION

The present invention relates to a route search device and a method for searching a route.

### BACKGROUND OF THE INVENTION

A route search device searches a route to a destination from a starting point based on a road data in a map data.

The device determines degree of matching between a current position of a vehicle and a road in a map data, on which the vehicle runs. When the device determines that the degree of matching is equal to or larger than a predetermined degree, the device makes a new road data based on a driving trajectory of the vehicle, and stores the new road data. Further, the device obtains additional information about the new road based on detection result of vehicle driving conditions, and records the additional information. After that, the device makes a new guiding route based on the road data already stored in the map data and the new road data in view of the additional information. This device is disclosed in, for example, JP-A-2000-018956.

In the above device, the new road data is created based on the driving trajectory. However, the device cannot search the route, which includes a section that is set by a user, according to a condition that is set by the user without depending on the road data in the map data.

### SUMMARY OF THE INVENTION

In view of the above-described problem, it is an object of the present disclosure to provide a route search device. It is another object of the present disclosure to provide a method for searching a route.

According to a first aspect of the present disclosure, a route search device for searching a route from a starting place to a destination based on a road data in a map data, the device includes: a path setting element for setting a path in a special section according to a search condition, wherein the special section is specified by an user, and wherein the search condition is specified by the user regardless of the road data; and a route searching element for searching the route including the path of the special section.

The above device can search the route including the special section, which is specified by the user, according to the search condition specified by the user.

According to a second aspect of the present disclosure, a method for searching a route from a starting place to a destination based on a road data in a map data, includes: storing a driving trajectory of a vehicle; specifying a part of or a whole of the driving trajectory; specifying a first starting point and a first end point of the part of or the whole of the driving trajectory; registering the part of or the whole of the driving trajectory together with the first starting point and the first end point as a first special section; storing multiple points as a memory point; specifying one of the memory points as a second starting point and another one of the memory points as a second end point; registering the second starting point and the second end point as a second special section; setting a search condition to include at least one of the first special section and the second special section; setting a path according to the search condition; and searching the route including the path according to the search condition.

The above method provides to search the route including the special section, which is specified by the user, according to the search condition specified by the user.

### BRIEF DESCRIPTION OF THE DRAWINGS

The above and other objects, features and advantages of the present invention will become more apparent from the following detailed description made with reference to the accompanying drawings. In the drawings:

FIG. 1 is a route search device;

FIG. 2 is a flowchart showing a section registration process;

FIG. 3 is a flowchart showing a memory point registration process;

FIG. 4 is a flowchart showing a route search process;

FIG. 5 is a schematic chart showing a step for searching a route from a starting place to a destination via a registered section;

FIG. 6 is a schematic chart showing a step for searching a route from a starting place to a destination via two memory points having off road information; and

FIG. 7 is a flowchart showing a route guiding process.

### DETAILED DESCRIPTION OF THE PREFERRED EMBODIMENTS

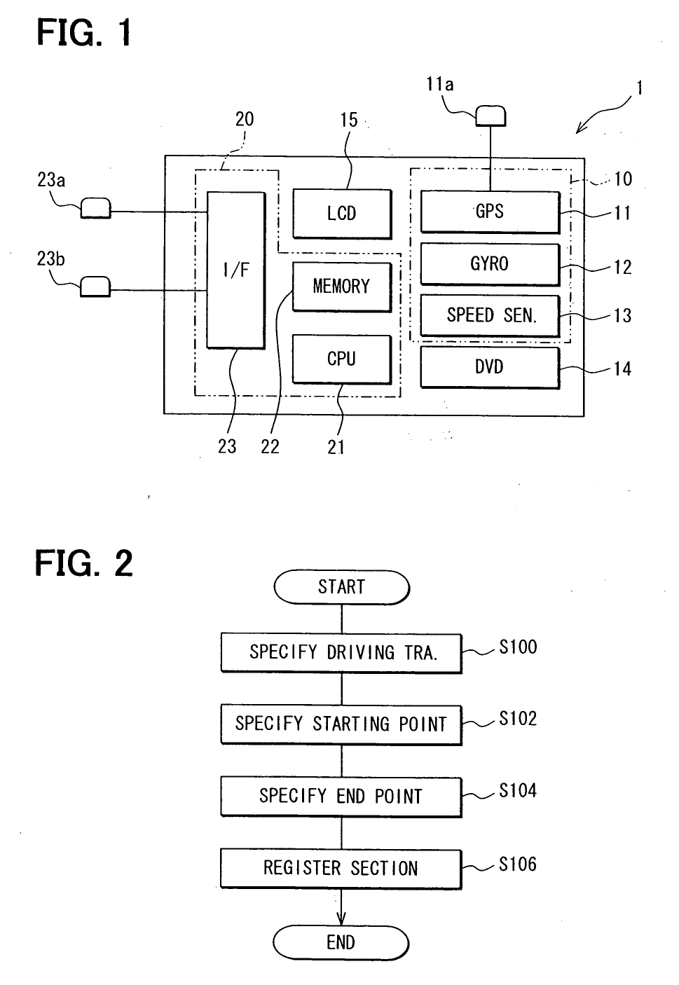

A route searching device 1 is shown in FIG. 1. The device 1 is an in-vehicle navigation device 1 mounted on a vehicle. The device 1 includes a position detector 10, a DVD device 14, a LCD 15 and a controller 20. The position detector 10 includes a GPS receiver 11 connecting to a GPS antenna 11a for receiving a GPS signal from a GPS artificial satellite, a gyroscope 12 and a speed sensor 13. The controller 20 includes a CPU 21, a memory 22 and an audio interface (i.e., audio I/F) 23. The GPS receiver 11, the gyroscope 12, the speed sensor 13, the DVD device 14, the LCD 15, the memory 22 and the audio I/F 23 are coupled with the CPU 21 via a wiring pattern on a circuit board or a connection cable.

The position detector 10 outputs information for specifying the current position of the vehicle and the driving direction of the vehicle based on detection signals of the GPS receiver 11, the gyroscope 12 and the speed sensor 13, and inputs the formation to the CPU 21.

The DVD device 14 reads out the map data from a DVD disk, which stores the map data.

The map data includes road data showing a distance of each link, a type of a road, the number of traffic lanes, a position of a traffic light and the like. Further, the map data includes a map matching data for improving the position detection accuracy, a landscape data for showing a position, a shape, a name and the like of a river, a lake, a sea, a railroad and a facility, and a facility data for showing a name, a location and a category of a facility in each region.

The LCD 15 displays different information on a liquid crystal display screen. The LCD 15 displays an image corresponding to an image signal from the CPU 21 on the screen.

The controller 20 is a computer including the CPU 21, the memory 22, the audio interface 23 and the like. The CPU 21 executes various process according to a program stored in the memory 22. The memory 22 is composed of a RAM, a ROM a flash memory and the like.

The audio I/F 23 is coupled with a speaker 23a for outputting sound and a microphone 23b for collecting voice of the user. The audio interface 23 converts a digital signal from the CPU 21 to an analog signal, and outputs the analog signal from the speaker 23a as sound output. Further, the audio interface 23 converts an analog signal from the microphone 23b to a digital signal, and inputs the digital signal to the CPU 21.

The navigation device 1 further includes a mechanical switch disposed around the screen of the LCD 15 and a touch switch overlapped on the screen of the LCD 15. The user operates the device 1 by using these switches.

The controller 20 in the navigation device 1 executes a current position calculation process, a map display process, a driving trajectory memorizing process, a destination searching process, a route searching process, a route guiding process and the like. The current position calculation process performs to calculate the current position and the driving direction of the vehicle based on the information for specifying the current position of the vehicle and the driving direction, which is input from the position detector 10. The map display process performs to display a vehicle position mark on a map around the current position of the vehicle on the screen. The driving trajectory memorizing process performs to memorize the driving trajectory of the vehicle from a starting point to an end point in a flash memory of the memory 22. The destination searching process performs to search the destination according to a searching condition that is set by the user operation. The route searching process performs to search an optimum route from the current position to the destination. The route guiding process performs to navigate the optimum route.

The navigation device 1 further executes the section registration process for registering a part of the section of the driving trajectory in the memory 22. The part of the section of the driving trajectory is set by the user. When the searching condition in the route searching process includes the registered part of the section of the driving trajectory, the device 1 searches the optimum route to include the registered part of the section.

FIG. 2 shows the section registration process. When an instruction signal to execute the section registration process is input by the user operation, the controller 20 executes the process shown in FIG. 2.

In Step S100, the driving trajectory is specified. Specifically, the list of the driving trajectory stored in the flash memory of the memory 22 is displayed on the screen. The user selects at least one part of the driving trajectory among the list. When the user selects a specific one part of the driving trajectory, the selected part of the driving trajectory is displayed and overlapped on the map of the screen.

Next, in Step S102, the starting point of the selected driving trajectory is specified. The starting point of the selected part of the driving trajectory is selected by pointing out a point on the selected part of the driving trajectory displayed on the screen.

In Step S104, the end point of the selected part of the driving trajectory is specified. The end point of the selected part of the driving trajectory is selected by pointing out a point on the selected part of the driving trajectory displayed on the screen.

In Step S106, the selected part of the driving trajectory together with the starting and end points is registered as a registered section. Specifically, the selected part of the driving trajectory specified in Steps S100-S104 is registered, i.e., memorized in the memory 22. Then, the section registration process ends.

The navigation device 1 further executes the memory point registration process, in which a memory point set by the user operation in addition to the off road information is registered, i.e., stored as a registered memory point. When the search condition in the route search process includes multiple registered memory points added with multiple off road information, the route is searched to include a path connecting among the registered memory points with straight lines. Specifically, when the registered memory points together with multiple off road information is selected as the search condition of the route search process, the route is searched and guided to include the path connecting among the registered memory points regardless of the road data in the map data.

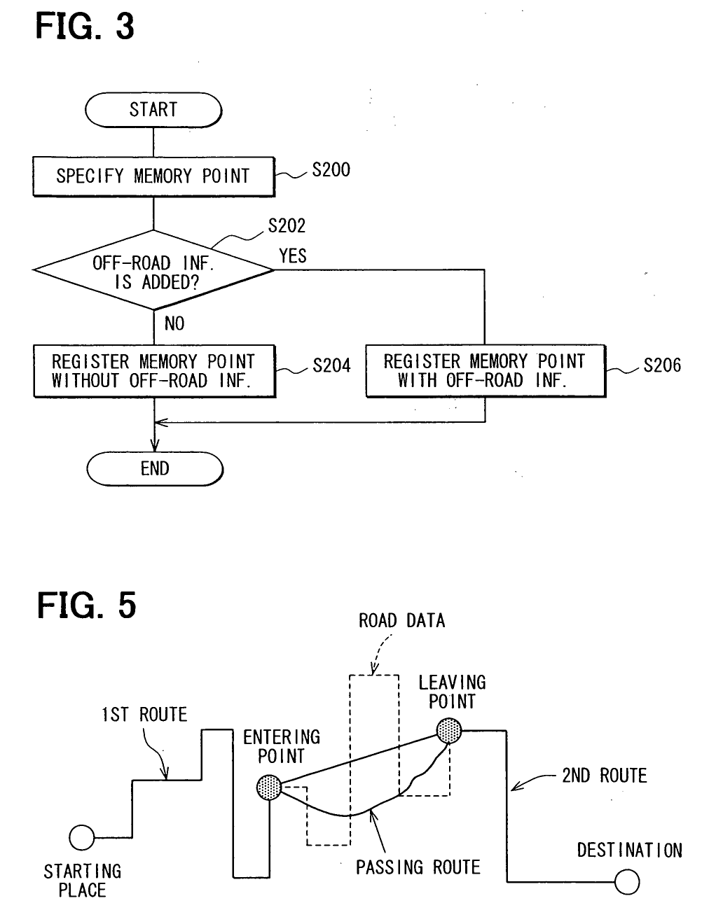

The memory point registration process is shown in FIG. 3. When an instruction signal showing the start of the memory point registration process in accordance with the user operation is input, the controller 20 executes the memory point registration process shown in FIG. 3.

In Step S200, the memory point is specified. Specifically, multiple memory points are displayed, and the user selects the memory point on the screen.

Next, in Step S202, it is determined whether the off road information is added. When the user selects the memory point according to the registered memory points, the image for confirming whether the off road information is added is displayed on the screen. Thus, in Step S202, it is determined by the user operation whether the off road information is added.

When it is determined that the off road information is not added, it proceeds to Step S204. In Step S204, the memory point is registered, i.e., stored without adding the off road information. Specifically, a flag representing the off road information is set to “0.” Then, the coordinate, i.e., a combination of the latitude and longitude of the memory point specified in Step S200 is stored in the flash memory of the memory 22. Thus, the memory point registration process ends.

When it is determined that the off road information is added, it proceeds to Step S206. In Step S206, the memory point is registered, i.e., stored with adding the off road information. Specifically, the flag representing the off road information is set to “1.” Then, the coordinate, i.e., a combination of the latitude and longitude of the memory point specified in Step S200 is stored in the flash memory of the memory 22. Thus, the memory point registration process ends.

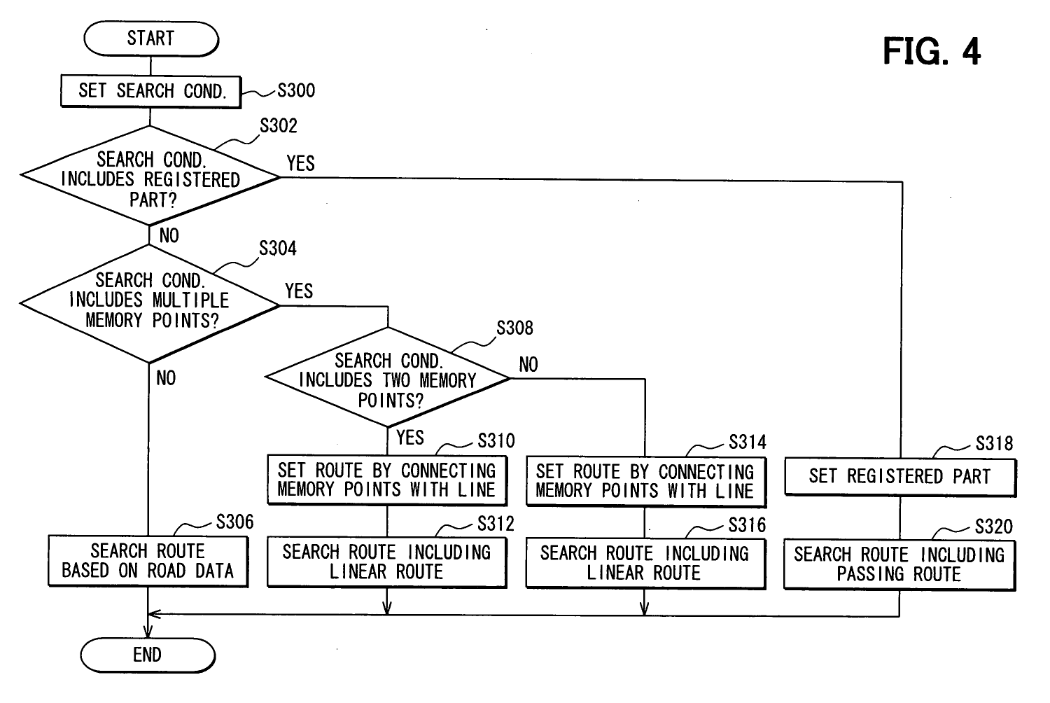

The route search process is shown in FIG. 4. The controller 20 executes the route search process when an instruction signal to perform the route search process is input by the user operation.

In Step S300, the search condition is set. Specifically, a setting image for the search condition is displayed on the screen. Thus, the starting place, the destination, the information whether the vehicle will pass the registered part of the driving trajectory in the section registration process, the information whether the vehicle will pass the registered memory point having the off road information in the memory point registration process, and the priority condition such as priority to time, priority to distance, priority to an ordinary road, and priority to an expressway are input by the user. Here, if there is no specific instruction, the starting place is set to the current position of the vehicle.

The information whether the vehicle will pass the registered part of the driving trajectory in the section registration process is set by, for example, displaying the list of the registered part and setting an entering point and a leaving point in the specified driving trajectory.

The information whether the vehicle will pass the registered memory point having the off road information in the memory point registration process is set by, for example, displaying the memory points having the off road information on the map, and setting one of the memory points. The information whether the vehicle will pass the registered memory point having the off road information may be set by selecting the memory point corresponding to the start point and the memory point corresponding to the end point, which are disposed in a section that the user requests to pass through. Alternatively, the information whether the vehicle will pass the registered memory point having the off road information may be set by selecting one or more memory points corresponding to a mid point between the start point and the end point. When the user selects multiple mid points, the user should select the mid points in order of passing through.

Accordingly, for example, when a new road has a linear shape, the user selects the start memory point and the end memory point of the new road. When the new road has a complicated shape, the user selects multiple mid memory points in addition to the start and end memory points in accordance with the road shape. Thus, the user may selects the memory points corresponding to the road shape of the new road.

In Step S302, it is determined whether the search condition includes the information about the registered part of the driving trajectory. Specifically, it is determined whether the route in the search condition includes the registered part of the driving trajectory in the section registration process.

In Step S304, it is determined whether the search condition includes two or more memory points having the off road information. Specifically, it is determined whether the route in the search condition includes multiple memory points having the off road information.

Here, when it is determined that the route in the search condition does not include the registered part of the driving trajectory, and further it is determined that the route in the search condition does not include multiple memory points having the off road information, it is determined to “NO” in Step S302 and “NO” in Step S304, and then, it proceeds to Step S306. In Step S306, the route is searched on the basis of the road data. Specifically, the route from the starting place to the destination is searched based on the road data.

When it is determined that the route in the search condition includes the registered part of the driving trajectory, it is determined to “YES” in Step S302. Then, in Step S318, the registered part of the driving trajectory is set to a passing route. Specifically, a section from the entering point to the leaving point of the registered part of the driving trajectory is defined as a special section, and the route including the registered part of the driving trajectory is set.

Next, in Step S320, the route is searched to include the registered part of the driving trajectory, which is set in Step S318. Specifically, the entering point of the passing route set in Step S318 is set to the destination, so that the first route from the starting place to the destination is searched. Further, the leaving point of the passing route set in Step S318 is set to the starting place, so that the second route from the starting place to the destination is searched. Thus, the route including the first route, the passing route and the second route is searched. Here, the first and second routes are determined based on the priority condition, so that the route from the starting place to the destination is searched based on the road map.

FIG. 5 shows a searching example of the route from the starting place to the destination via the registered part of the driving trajectory, i.e., the passing route. The section between the entering point and the leaving point is the passing route to drive according to the registered part of the driving trajectory. The section from the starting place to the entering point is set to the first route searched based on the road data. The section from the entering point to the leaving point is set to the passing route, through which the vehicle drives along with the registered part of the driving trajectory regardless of the road data, which is shown as a dotted line. The section from the leaving point to the destination is set to the second route, which is searched based on the road data. Thus, the route from the starting place to the destination via the first route, the passing route and the second route is generated.

When it is determined that the route in the search condition does not include the registered part of the driving trajectory, and further it is determined that the route in the search condition includes multiple memory points having the off road information, it is determined to “NO” in Step S302 and “YES” in Step S304, and then, it proceeds to Step S308. In Step S308, it is determined whether the number of the multiple memory points in the searching condition is two. Specifically, it is determined whether the route in the search condition includes two or more memory points having the off road information.

When the route in the search condition includes two memory points having the off road information, it is determined to “YES” in Step S308. Then, it proceeds to Step S310. In Step S310, the passing route is set to connect between two memory points with a straight line. In Step S300, the memory point corresponding to the starting point and the memory point corresponding to the end point are specified, and therefore, the passing route is set to linearly connect the section between the starting point and the end point.

Next, in Step S312, the route including the passing route is searched. Specifically, the starting point of the passing route set in Step S310 is set to the destination, so that the first route from the starting place to the destination is searched. Further, the end point of the passing route set in Step S310 is set to the starting point, so that the second route from the starting point to the destination is searched. Thus, the route from starting place to the destination via the first route, the passing route set in Step S310, and the second route is searched.

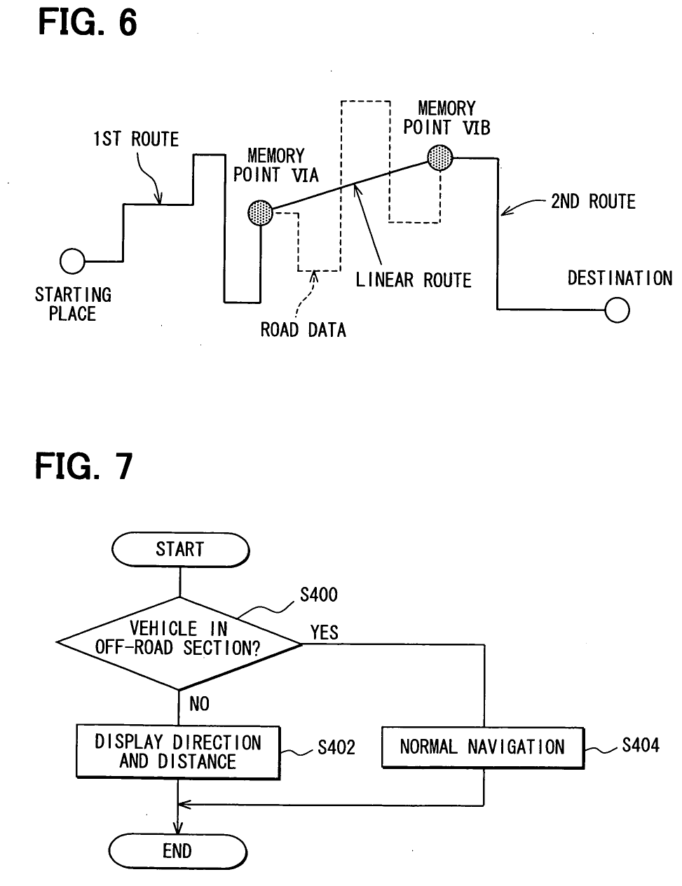

FIG. 6 shows a searching example of the route from the starting place to the destination via the two memory points having the off road information. The section from the memory point VIA to the memory point VIB is set to the passing route, i.e., the linear route by connecting the stored memory points VIA, VIB with the line. The section between the starting place and the memory point VIA is set as the first route, which is searched based on the road data. The section between the memory point VIA and the memory point VIB is set to the passing route by connecting two memory points VIA, VIB with the line. The section between the memory point VIB and the destination is set to the second route, which is searched based on the road data. Thus, the route from the starting place to the destination via the first route, the passing route and the second route is generated.

When the route in the search condition includes multiple memory points having the off road information, and further, the route in the search condition includes three or more memory points, it is determined to “YES” in Step S304 and “NO” in Step S308. Then, it proceeds to Step S314. In Step S314, the passing route is set to connect between the memory points with the line. In Step S300, the memory point corresponding to the starting point, the memory point corresponding to the end point, and one or more mid points are selected. The portion between the starting point and a mid point is connected with a line. Another portion between the mid point and the end point is connected with another line. When the number of the mid points is equal to or larger than two, further another portion between two adjacent mid points is connected with further another line. Thus, the route is set. Here, when the number of mid points is larger than two, the passing route is set to pass the mid points in the order selected in Step S300.

Next, in Step S316, the route including the passing route set in Step S314 is searched. Similar to Step S312, the starting point of the passing route set in Step S314 is set to the destination, so that the first route from the starting place to the destination is searched. Further, the end point of the passing route set in Step S314 is set to the starting point, so that the second route from the starting point to the destination is searched. Thus, the route from starting place to the destination via the first route, the passing route set in Step S314, and the second route is searched.

In the route search process, the route is generated to pass the registered part of the driving trajectory or the linear route connecting among multiple memory points having the off road information. Here, the passing route such as the registered part and the linear route is defined as an off road section, so that the off road section does not relate to the road data. The route includes the off road section, and therefore, the navigation device 1 does not navigate the route, i.e., the road to the destination in the off road section. For example, the device 1 does not navigate right/left turn guide and traffic lane change guide.

The navigation device 1 executes the route guiding process such that a method for guiding the route in a case where the vehicle drives in the off road section is different from that in a case where the vehicle drives in a section other than the off road section.

FIG. 7 shows the route guiding process. In Step S400, the controller 20 determines whether the vehicle is disposed in the off road section. Specifically, it is determines whether the vehicle is disposed in the off road section based on the current position of the vehicle calculated in the current position calculation process and the route generated in the route search process.

When the vehicle is not disposed in the off road section, for example, when the vehicle is disposed in the section between the starting place and the memory point VIA shown in FIG. 6, it is determined to “NO” in Step S400. Then, it proceeds to Step S404. In Step S404, normal navigation is performed. Specifically, the device 1 displays a navigation image on the screen. The navigation image includes the vehicle position mark and the route to the destination overlapped on the map. Further, the device 1 navigates the right/left turn guide before an intersection of the road, and navigates the traffic lane change guide before a point, at which the vehicle should change the traffic lane.

When the vehicle enters into the off road section, it is determined to “YES” in Step S400. In Step S402, the direction and the distance to the destination are displayed on the screen. Specifically, the device 1 displays a navigation image such that the vehicle position mark is overlapped on the route, which is shown as the line or the driving trajectory. Further, the device 1 displays the compassing direction representing north, south, east and west, a remaining distance from the current position to the end point of the off road section, and a remaining distance from the current position to the destination. Here, the remaining distance from the current position to the end point of the off road section may be calculated as a linear distance based on the coordinates of the current position and the coordinates of the end point of the off road section. Even when the off road section includes the registered part of the driving trajectory, the remaining distance from the current position to the end point of the off road section may be calculated as the linear distance from the current position of the vehicle top the end point (i.e., the leaving point) of the off road section. The remaining distance between the current position and the destination may be calculated by adding the linear distance between the current position and the end point of the off road section with the distance from the end point of the off road section to the destination. Here, the distance from the end point of the off road section to the destination is calculated based on a link length (i.e., road length) of the road data.

When the vehicle drives in the section (i.e., the second route) from the memory point VIB to the destination shown in FIG. 6, it is determined to “NO” in Step S400. Then, in Step S404, the device 1 executes the normal navigation.

In the above device 1, the user selects a special section, and the user sets a path driving through the special section according to the user instruction regardless of the road data. The device 1 searches the route including the special section such as the passing route and the linear route.

When the starting point and the end point of the special section are selected as a passing point in the search condition, the starting point and the end point defining the special section, the device 1 sets the route to connect between the starting point and the end point of the special section with the straight line. For example, when a new road is established, the user registers the starting and end points of the new road as the points defining the special section. When the user selects the starting and end points as the passing points of the search condition, the special section as the passing route is set to connect the starting and end points of the new road with the straight line.

Further, when the mid point between the starting and end points of the special section is selected by using the point defining the special section, the passing route is set to connect between the starting point and the end point via the mid point with multiple straight lines. Accordingly, when the new road has a complicated shape, the user may select multiple points as a passing point long with the road shape, so that the special section, i.e., the passing route corresponding to the road shape can be set.

When a part of or a whole of the driving trajectory registered preliminarily is selected as the special section for passing therethrough in the search condition, the route is searched to include the passing route for driving along with the part of or the whole of the driving trajectory. For example, the user registers the part of or the whole of the driving trajectory of the new road as the special section after the vehicle runs in the new road. The user selects the registered part of or the registered whole of the driving trajectory as the special section in the search condition so that the vehicle drives through the special section. Thus, the user sets the route for driving along with the driving trajectory of the new road in the special section.

The passing route in the special section is set regardless of the road data. Therefore, for example, the user may lose the driving direction of the vehicle when the vehicle runs on a wide plain. In this case, the navigation device 1 displays the compassing direction for showing the driving direction on the screen. Thus, the user can recognizes the driving direction of the vehicle easily.

The route in the special section is set regardless of the road data. At least one of the distance between the current position and the end point of the special section and the distance between the current position and the destination is displayed on the screen. Therefore, the user recognizes the distance between the end pint of the special section and the current position and the distance between the current position and the destination easily.

In the above embodiment, the route is searched such that the special section as the passing route is disposed between the starting place and the destination. Alternatively, the starting place may be the starting point of the special section, and the destination may be the end point of the special section.

In the above embodiment, the part of the driving trajectory is registered in the section registration process. Alternatively, a whole of the driving trajectory may be registered as the special section.

In Steps S310, S314, the passing route is set such that the memory points are coupled with the lines. Alternatively, the passing route may be prepared such that the memory points are coupled with a curve.

In the above embodiment, when the search condition is set in Step S300, either one of the two cases is selected in the search condition, one case where the searching route includes the passing route registered in the section registration process, and the other case where the searching route includes multiple memory points having the off road information in the memory point registration process. Alternatively, the searching route may include both of the passing route and the linear route. Specifically, the search condition is selected such that the route includes the passing route registered as the driving trajectory and the linear route for connecting multiple memory points with the straight lines. Thus, the searching route includes both routes.

Steps S310, S314, S318 provide a path of a special section setting element. Steps S312, S316, S320 provide a route searching element. The memory point registration process corresponds to a point registration element. The section registration process shown as Steps S100 to S106 provide a section registration element. Step S400 provides a section determination element. Step S402 provides a navigation element.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A route search device for searching a route from a starting place to a destination based on a road data in a map data, the device comprising:
a path setting element for setting a path in a special section according to a search condition, wherein the special section is specified by an user, and wherein the search condition is specified by the user regardless of the road data; and
a route searching element for searching the route including the path of the special section.

2. The device according to claim 1, further comprising:
a controller for inputting information of the special section and the search condition by the user.

3. The device according to claim 1, further comprising:
a point registration element for registering a starting point and an end point, which define the special section,
wherein the path setting element sets the path in such a manner that the starting and end points of the special section are coupled with a straight line as the path when the search condition is specified to include the starting and end points as a passing point of the route.

4. The device according to claim 3,
wherein the point registration element registers at least one mid point between the starting point and the end point, the mid point defining the special section, and
wherein the path setting element sets the path in such a manner that the starting point and the at least one mid point of the special section are coupled with a first line as a part of the path, and the at least one mid point and the end point of the special section are coupled with a second line as another part of the path when the search condition is specified to include the starting point, the at least one mid point and the end point as a passing point of the route.

5. The device according to claim 1, further comprising:
a section registration element for registering a part of or a whole of a driving trajectory, which defines the special section,
wherein the path setting element sets the path in such a manner that the path includes the part of or the whole of the driving trajectory in the special section when the search condition is specified to include the part of or the whole of the driving trajectory as a passing route of the route.

6. The device according to claim 1, further comprising:
a section determination element for determining whether a current position of the device is disposed in the special section; and
a navigation element for navigating the route and for displaying a compassing direction on a screen when the section determination element determines that the current position is disposed in the special section.

7. The device according to claim 6,
wherein the navigation element displays at least one of a distance between the current position and an end point of the special section and a distance between the current position and the destination.

8. A method for searching a route from a starting place to a destination based on a road data in a map data, comprising:
storing a driving trajectory of a vehicle;
specifying a part of or a whole of the driving trajectory;
specifying a first starting point and a first end point of the part of or the whole of the driving trajectory;
registering the part of or the whole of the driving trajectory together with the first starting point and the first end point as a first special section;
storing multiple points as a memory point;
specifying one of the memory points as a second starting point and another one of the memory points as a second end point;
registering the second starting point and the second end point as a second special section;
setting a search condition to include at least one of the first special section and the second special section;
setting a path according to the search condition; and
searching the route including the path according to the search condition.

9. The method according to claim 8,
wherein the route from the starting place to the first staring point is searched based on the road data when the route includes the first special section,
wherein the route from the first end point to the destination is searched based on the road data when the route includes the first special section,
wherein the route from the starting place to the second staring point is searched based on the road data when the route includes the second special section, and
wherein the route from the second end point to the destination is searched based on the road data when the route includes the second special section.

10. The method according to claim 9,
wherein the route includes the part of or the whole of the driving trajectory as the path when the route includes the first special section,
wherein the route includes a linear route as the path when the route includes the second special section, and
wherein the linear route is formed by connecting the second starting point and the second end point.
